(19) United States
(12) Patent Application Publication
(10) Pub. No.: US 2004/0105256 A1
(43) Pub. Date: Jun. 3, 2004

(54) Virtual color generating windmills, spinners, and ornamental devices powered by solar or wind energy

(76) Inventor: Timothy R. Jones, Jackson, MI (US)

Correspondence Address: Timothy R. Jones, 5900 S. Meridian Rd, Jackson, MI, 49201, US

(21) Appl. No.: 10/720,414

(22) Filed: Nov. 24, 2003

Related U.S. Application Data
(60) Provisional application No. 60/428,558, filed on Nov. 22, 2002.

(51) Int. Cl. F21L 19/00

(52) U.S. Cl. 362/159; 362/166; 362/170

(57) ABSTRACT

A device powered by solar or wind energy that produces multicolored lighting effects by virtue rotation or movement caused by air currents or the wind. Solar cells or a electromechanical generator produce electrical energy that stored through a control circuit for use at nighttime to power a number of light emitters. Air currents induce movement of the light emitters, or movement of the entire energy storage system, with the resulting visual effect of intermixing and changing colors as the rotation or movement varies in response to the force of the air currents.

A priority filing date is claimed through provisional patent application No. 60/428,558, filed by the applicant on Nov. 22, 2002, which describes the instant invention.

### BACKGROUND OF THE INVENTION

The field of the invention pertains to illuminating decorative and toy devices that are powered by captured solar or wind energy and produce artistic colored lighting effects due to rotation or movement caused by the wind or air currents.

A limitation of available nighttime ornamental and outdoor garden lighting devices is that they only create static and monochromatic lighting effects at night. Available technology that could produce interesting moving or dynamic artistic lighting effects have drawbacks such as 1) the cost, inconvenience, and dangers of electrical wires connecting outdoor devices, 2) the wear of rotatable electrical connectors and 3) the cost and complexity of movement actuators to provide entertaining light shows.

A recent alternative for creating entertaining color-changing light displays is described in the applicant's April 29^{th}, 2002, Provisional Patent Application #60/376,088. Here, a wind electric generator powers light emitters of various colors that are mounted on small windmills and spinners to produce moving and virtual colors. However, a minimum wind speed is needed to produce an entertaining light show. Unfortunately, the appeal of these devices is often limited by low winds, which are most common at night and during the summer season when people are most disposed to being outdoors or in their gardens. Consequently, the incorporation of a energy storage system to capture solar or wind energy during the daytime will allow for greater appeal by virtue of higher and more consistent light output at nighttime.

### BRIEF SUMMARY OF THE INVENTION

Multicolored light emitters are mounted upon windmill blades, the body of a wind spinner, or other shape moved by air currents. The light emitters are powered by solar or wind energy captured and stored during the day so the subtle nighttime breezes spin the illuminated device to produce moving colors. Virtual changing colors appear to be produced as the speed of rotation of the devices varies with the wind speed of the breezes.

### BRIEF DESCRIPTION OF THE DRAWINGS

The invention is better understood and the objects other than those set forth become more apparent by consideration of the detained description. The later description makes reference to the following drawings:

FIG. 1 is a schematic front plan view of the blades for the tailless windmill form of the invention.

FIG. 2 is a side plan view of the tailless windmill form of the invention with support pole.

FIG. 3 is a schematic diagram of the wind electric generator directly connected light emitting diodes.

FIG. 4 is a top view of savonius rotor form of the invention, which serves at the basis for top views of FIGS. 5, 6, and 7.

FIG. 5 is a side view of a rotatable housing.

FIG. 6 is a side view of a hanging form of the invention encased within the rotatable housing.

FIG. 7 is a side view of the hanging form of the invention showing a loop for mounting.

FIG. 8 is a side view of the weathervane for of the invention.

FIG. 9 if a front view of the invention adapted to conventional pinwheel wind rotor.

### DETAILED DESCRIPTION OF THE INVENTION

The new devices for the generation of moving two and three dimensional shapes and virtual changing colors consists of a windmill, wind spinner, housing or shape that is moved or rotated by the wind or air currents and contains an energy capture and storage system powering multicolored light emitters. The devices illuminate at night through a control circuit in different colors and rotate in response to the wind. At nighttime the devices may appear as a stationary pattern or a mobile of colored lights in a low wind while appearing as a fiery blizzard of changing colors rapidly spinning and tracking in a brisk wind. These devices overcome the intermittent and unreliable nature of the lighting effects product by the devices described in the April 2002 Provisional Patent application because they are more consistently illuminated.

There are two basic forms of energy that these devices use to capture energy. The solar energy powered devices use solar or photovoltaic cells for the collection of solar energy and a control circuit that directs charging of the storage system and initiates and optimizes illumination upon. Light emitters of different colors are connected to the energy storage system via the control circuit so that as the weather-resistant housing spins by the wind acting on external blades or the housing shape, the light emitters are differentially presented the viewer thus giving an entertaining light display. The entire unit is designed so that dynamic lighting effect is coordinated to aerodynamic rotation.

The solar cells are electrically connected through a diode, one-way current device, electron valve, integrated circuit, microchip, or control circuit to allow the electron storage component is charged during daylight while preventing current drain back to the solar cells at night. A battery, batteries, or capacitor may be used, with a preference to NiCad, nickel metal halide, or of other rechargeable battery technology to supply electrical power to light emitting diodes (“LED”) or lamps for an optimal or determined time period. The entire device is strategically designed so that wobbly or unbalanced rotation is eliminated.

Preferably, between the solar collector, batteries, and the light emitters is a control circuit that provides additional functions for the device. The control circuit may regulate the charging of the batteries, prevent current drain by the solar collectors at night, and control light emitters or even a sound generator. For example, the lamps may be alternately biased and pulsed by a short duration electrical pulse to produce the highest apparent brightness without impairing the usefulness of the light emitters. The circuit may modify the voltage, polarity, or current supplied to optimize apparent brightness, the pulse rate, and to conserve electrical energy and economize product cost. Likewise, an accelerometer, centrifugal switch, microprocessor, or sensor may actively alter the pulse rate, the lamps or colors illuminated, or pattern in response to the rotational speed or other condition of the device. Similarly, the control circuit may modify the flash rate, brightness, or color lighted in response to the ambient temperature, wind speed, humidity, rain, or other environmental factor to provide useful information to the viewer. Alternatively, the device may simply illuminate at night and rotate with multicolored light emitters.

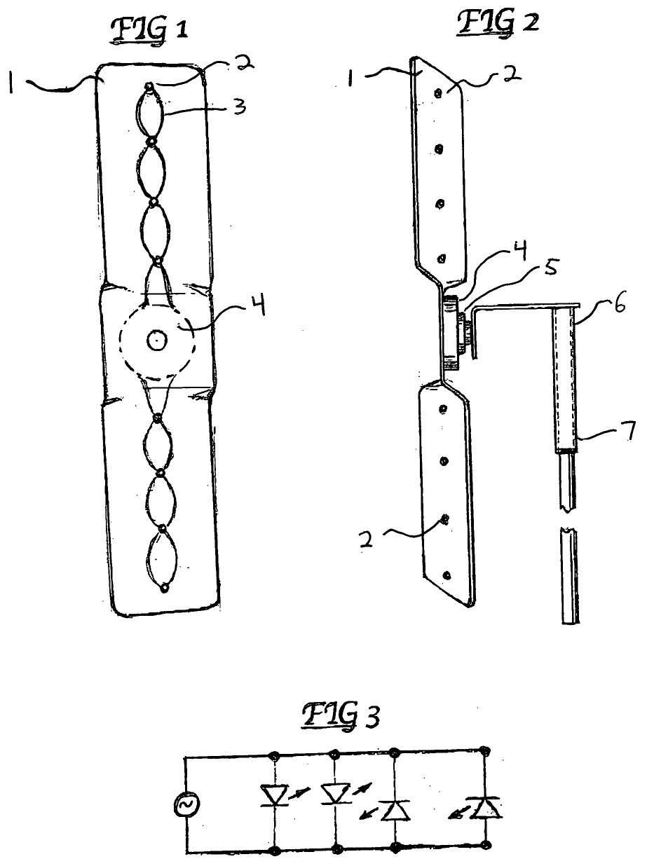

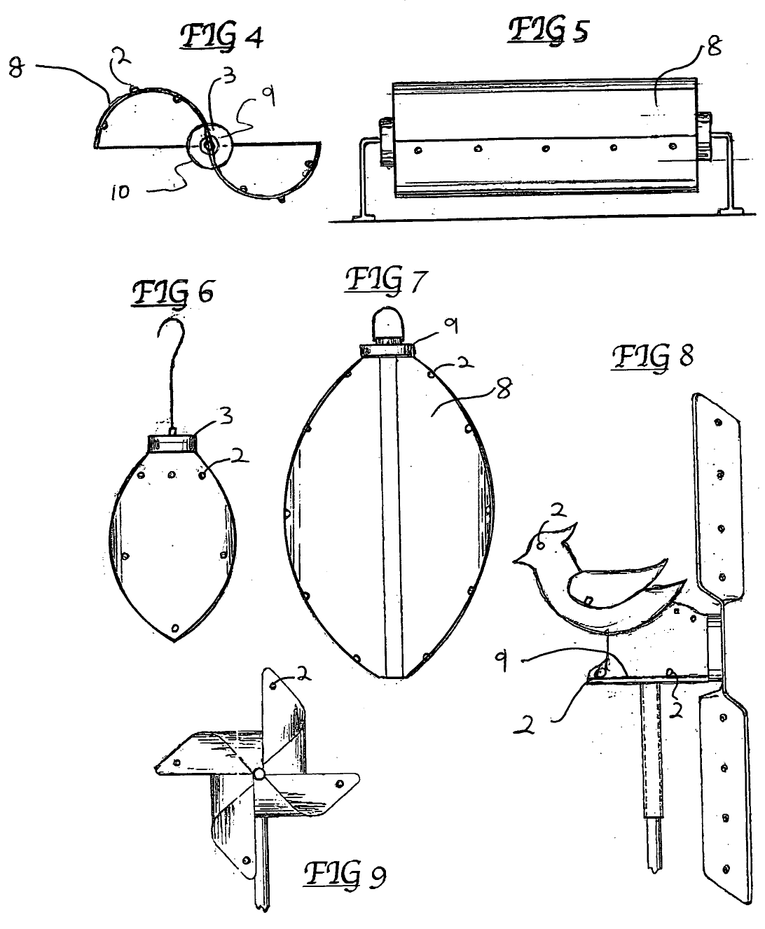

With reference to FIGS. 1 through 9, and in particular to FIGS. 4, 5, 7, and 8: Multicolored light emitters 2 are mounted on savonius or wind-reactive housing 8, electromechanical generator 3 powering control and electrical storage system 8 (hidden). With FIG. 7, solar cells 9 top the control and electrical storage components 10 that power light emitters 2. Solar cells 9 are mounted on the base of the weather vane shape.

In the second form of the device, the energy source is a generator or electromotive generator that converts wind currents into electrical energy. For either form of the device, the completed electrical system, as described above, may be designed to supply direct current or alternating current to power light emitters of virtually any type and is not limited to LED's. An advantage to the use of an alternating current with LED's in the preferred prototypes is that two of conductors may power LED's of differing electrical characteristics so that different LED'S are alternatively pulsed and illuminated with interesting visual effects while conserving product cost.

The light emitters are mounted in or about the housing structure in such fashion to produce interesting patterns and shapes. In one design constructed the light emitters were mounted so that their respective beams of light were considerably parallel and outward from the center of rotation, while in another prototype they are mounted at various divergent angles so that the viewing angle of the observer affects which color of light emitter is perceived. The light emitters may be placed at or near the radius of rotation of the blade or device, producing a number of essentially circular rings of light caused by the afterimage effect of the human eye. Additionally, light emitters of two or more colors may exist within the same path of rotation, with or without pulsing and control electronics, to produce various apparent colors as the rotational speed of the device varies in response to changes in the wind speed or direction. The housing may be transparent or perforated to allow emitted light to pass through the housing and to the viewer.

Addressing FIGS. 1 and 2, windmill blades 2 contain multicolored light emitters 2, which are connected by wires 3 to the control circuit and electrical storage device 5. The windmill is rotatable to track the wind via the mounting coupling 6 over the support pole 7.

The entire electrical system, whether solar or wind powered, is contained within a sealed housing that reacts and moves in response to air currents because of the shape of the housing. The entire system means the interconnected energy generator, storage batteries, control circuit, and light emitters. Another option is wind reactive blades or protrusions extending from the housing. A small pivot, ball bearing, elastic cable, or other pivotable mechanism allows the entire device to easily rotate in a light wind. Electrically conductive slip rings are not used, although this possibly should not be excluded for some forms of the device.

The ultimate form of the device may be a conventional windmill or pinwheel with rotating illuminated blades, a weather vane with or without illuminated rotating blades, or a static or moving illuminated shape of two or three dimensions. The devices may be hanging or pole mounted and function as a mobile or other forms of art, or even corkscrews that rotate with the wind. The housing may be of any material. However clear, transparent or even translucent plastic material that is tinted are particularly appealing. The illumination effect may be to cast a spray of colors as described above, to illuminate a light conductive plastic or other material of interesting shape or surface ornamentation, or to cast light back upon the housing or rotating shape to create attractive visual effects. An effect deserving of further mention is the selective illumination of different layers of light conductive plastic by different colors of light. A shape or form is build up with these different layers to provide interesting lighted effects. Naturally, all of the effects would be most interesting with low ambient light levels or at nighttime. Other materials preferable for the construction of the housing might include copper, aluminum or other metals. For example, a conventional weather vane could be illuminated at night. The weather vane would contain the energy storage system encapsulated within the base or even the actual weather vane shape. The solar collector is mounted upward while the light emitters may be mounted so that they shine upon the exterior shape of the weather vane. Light emitters may also internally light the shape or light it at particular points such as the eyes of a rooster. Nighttime utility is added to the conventional weather vane because it is illuminated as it tracks the wind direction.

Another embodiment of interest is the development of lighted ornaments that may hang from a string or cable or be mounted on a pole. Here the energy storage system is encapsulated within a housing of elegant shape, profile, or construction such that external projections, wings, or blades induce rotation of the entire housing with a light breeze or wind. A pivot or bearing would allow the free rotation of the device from the mount or attachment. Again, the flash rate, pattern, color lighted or sequencing of the illumination effect may be varied with the rate of rotation to produce entertaining visual effects. A programmable control or electronic circuit would allow for various effects and behaviors to selected, thus providing additional nighttime entertainment.

Another form of the housing that would induce rotation would be based on the Savonius vertical axis wind rotor. The actual rotor blades may be cut or produced so that when spinning a shape such as an egg, triangle, square, or even surrealistic shapes are produced. Here the end caps or disks of the Savonius rotor are minimized to help form the three-dimensional shape; naturally there is some loss in rotor efficiency with these modifications. Numerous other shapes are possible not limited to the above examples. The devices using wind energy have interposed between the generator and the light emitters is a control circuit and high capacity battery system designed for the storage of electrical energy. During daylight hours the windmill, pinwheels, or spinners spin and thus generate electrical energy because of the generator. The control circuit senses daylight and prevents the light emitter from being powered while diverting the electrical energy to the battery. Daytime winds are generally higher than nighttime winds, causing additional energy being stored. A light sensor or photosensitive circuit indicates darkness to a circuit which then switches-on the light emitters. Thus the generator and the battery can power the light emitters independently or together while the control circuit limits over current and voltages. The effect is more continuous lighting at night even though the wind is low or nonexistent, making even a slowly rotating windmill more interesting to viewers.

The solar energy devices and the devices that store energy derived from a windmill, pinwheel, or other type of wind powered system have applications such as ornaments, garden displays, boating applications, house markers, art displays, golf courses, toys, and numerous other applications obvious from the devices. Commercial applications could be to attract attention to stores or businesses, grand openings, and public events. Of particular note are the possible shapes that can be developed from the Savonius rotor principals; Bird and bat shapes, bird wings, diamonds, triangles, the list could be endless.

What I claim as my invention is:

1. A device comprising:
A solar energy capture system incorporating a control system to power multicolored light emitters that is rotatable by air currents about one or more axis of the device.
A windmill, spinner, or mobile-like device containing a solar energy capture system to supply nighttime power to multicolored light emitters that are dynamically moved by air currents.

2. A Wind electric generator connected to a control and energy storage system to power multicolored light emitters that undergo movement with air currents or the wind.
